(19) United States
(12) Patent Application Publication
(10) Pub. No.: US 2025/0345916 A1
(43) Pub. Date: Nov. 13, 2025

(54) RATCHET TOOL WITH REVERSING MOTOR

(71) Applicant: MILWAUKEE ELECTRIC TOOL CORPORATION, Brookfield, WI (US)

(72) Inventors: Jordan P. Gilsinger, Sussex, WI (US); Evan Brown, Milwaukee, WI (US); Andrew D. Bendtsen, Oak Creek, WI (US); Josh Navin, Brookfield, WI (US); Benjamin D. Andersen, Menomonee Falls, WI (US); Jacob R. Seifert, Lake Mills, WI (US)

(21) Appl. No.: 19/202,836

(22) Filed: May 8, 2025

Related U.S. Application Data
(60) Provisional application No. 63/644,918, filed on May 9, 2024.
(60) Provisional application No. 63/663,404, filed on Jun. 24, 2024.

(51) Int. Cl. B25F 5/00; B25B 21/00; H02P 23/24

(52) U.S. Cl. CPC B25F 5/001; B25B 21/004; H02P 23/24; B25B 21/002

(57) ABSTRACT

A power tool includes a housing, a motor supported within the housing, the motor including a motor shaft, a selector movable between a first position and a second position, an output, a drivetrain coupling the motor shaft to the output, an actuator, and a controller configured to operate the motor to rotate the motor shaft in a first direction in response to a first actuation of the actuator, and to reverse the motor to rotate the motor shaft in a second direction opposite the first direction in response to a second actuation of the actuator following the first actuation.

### CROSS-REFERENCE TO RELATED APPLICATIONS

This application claims priority to U.S. Provisional Patent Application No. 63/663,404, filed Jun. 24, 2024, and to U.S. Provisional Patent Application No. 63/644,918, filed May 9, 2024, the entire content of each of which is incorporated herein by reference.

### FIELD

The present disclosure relates to power tools, such as ratchet tools, and, more particularly, to motor control for power tools.

### BACKGROUND

Ratchet tools may facilitate tightening or loosening a fastener in a confined space where rotation of a tool about a 360 degree axis cannot be undertaken. To that end, a ratchet assembly of a ratchet tool provides for tightening of a fastener in one rotational direction while allowing free rotation of the ratchet tool in the opposite direction, thereby providing uni-directional tightening of the fastener without subsequently loosening the fastener as the ratchet tool is rotated in the opposite direction, without having to disengage the ratchet tool from the fastener to continue the fastening operation.

Power tools, including ratchet tools, typically include a plurality of drivetrain components (e.g., shafts, gears, etc.) with clearances between coupled components resulting from manufacturing tolerances and clearance fits. The amount of relative rotation that may occur due to these clearances between components otherwise coupled for co-rotation is referred to as backlash.

### SUMMARY

The present disclosure provides, among other things, a power tool, such as a ratchet tool, with a motor and a controller configured to operate the motor in a manner to use the backlash to increase a torque output of the tool. By driving the motor in a first direction and then reversing the motor to drive in a second, opposite direction, the motor may accelerate before any significant torque load is experienced by the motor. The acceleration of the motor provides rotational inertia that may provide the power tool with additional torque output.

For example, in some aspects, the techniques described herein relate to a power tool including: a housing; a motor supported within the housing, the motor including a motor shaft; a selector movable between a first position and a second position; an output; a drivetrain coupling the motor shaft to the output; an actuator; and a controller configured to operate the motor to rotate the motor shaft in a first direction in response to a first actuation of the actuator, and to reverse the motor to rotate the motor shaft in a second direction opposite the first direction in response to a second actuation of the actuator following the first actuation, wherein, when the selector is in the first position, the output is rotatable in a first output direction in response to rotation of the motor shaft in the first direction and in response to rotation of the motor shaft in the second direction, and wherein, when the selector is in the second position, the output is rotatable in a second output direction opposite the first output direction in response to rotation of the motor shaft in the first direction and in response to rotation of the motor shaft in the second direction.

In some aspects, the techniques described herein relate to a power tool, wherein the power tool includes a clearance region at least partially defined by tolerances in the drivetrain, wherein the motor shaft is rotatable relative to the output within the clearance region.

In some aspects, the techniques described herein relate to a power tool, wherein, after reversing the motor, the controller accelerates the motor shaft in the second direction through the entire clearance region before torque is transmitted from the motor shaft to the output.

In some aspects, the techniques described herein relate to a power tool, wherein the drivetrain includes a planetary transmission and a ratchet assembly.

In some aspects, the techniques described herein relate to a power tool, wherein the controller is configured gradually reduce power supplied to the motor when the actuator is released.

In some aspects, the techniques described herein relate to a power tool, wherein the controller is configured to reduce power supplied to the motor by 10% or less per millisecond when the actuator is released.

In some aspects, the techniques described herein relate to a power tool, wherein the controller is configured to brake the motor to stop rotation of the motor shaft after gradually reducing power supplied to the motor.

In some aspects, the techniques described herein relate to a power tool including: a housing; a motor supported within the housing, the motor including a motor shaft; an output; a drivetrain coupling the motor shaft to the output such that rotation of the motor shaft rotates the output; an actuator; and a controller configured to operate the motor to rotate the motor shaft in a first direction or a second direction opposite the first direction in response to actuation of the actuator, gradually reduce power supplied to the motor by 10% or less per millisecond when the actuator is released, and brake the motor to stop rotation of the motor shaft after gradually reducing the power supplied to the motor.

In some aspects, the techniques described herein relate to a power tool, wherein the drivetrain includes a planetary transmission and a ratchet assembly.

In some aspects, the techniques described herein relate to a power tool, wherein the controller is configured to reduce power supplied to the motor by 5% per millisecond when the actuator is released.

In some aspects, the techniques described herein relate to a power tool, wherein the controller is configured to operate the motor to rotate the motor shaft in the first direction in response to receiving a signal from the actuator, and to reverse the motor to rotate the motor shaft in the second direction once a predetermined time period has elapsed after receiving the signal.

In some aspects, the techniques described herein relate to a power tool, wherein the predetermined time period is between 10 milliseconds and 100 milliseconds.

In some aspects, the techniques described herein relate to a power tool, wherein the power tool includes a clearance region at least partially defined by tolerances in the drivetrain, wherein the motor shaft is rotatable relative to the output within the clearance region.

In some aspects, the techniques described herein relate to a power tool, wherein, after reversing the motor, the controller accelerates the motor shaft in the second direction through the entire clearance region before torque is transmitted from the motor shaft to the output.

In some aspects, the techniques described herein relate to a power tool, wherein the controller is configured to operate the motor to rotate the motor shaft in the first direction in response to a first actuation of the actuator, and to reverse the motor to rotate the motor shaft in the second direction in response to a second actuation of the actuator following the first actuation.

In some aspects, the techniques described herein relate to a power tool, wherein the controller is configured to reverse the direction of rotation of the motor shaft each time the actuator is actuated.

In some aspects, the techniques described herein relate to a power tool, wherein the controller is configured to detect if the motor stalls during operation of the power tool, and wherein the controller is configured to reverse the motor in response to a detected stall.

In some aspects, the techniques described herein relate to a power tool including: a housing; a motor supported within the housing, the motor including a motor shaft; an output rotatable in response to rotation of the motor shaft; a drivetrain coupling the motor shaft to the output; an actuator; and a controller, wherein the power tool includes a clearance region at least partially defined by tolerances in the drivetrain, wherein the motor shaft is rotatable relative to the output within the clearance region, wherein the drivetrain includes a ring gear that is rotatable relative to the housing.

In some aspects, the techniques described herein relate to a power tool, wherein the drivetrain includes a collar coupled to the housing, wherein the collar receives the ring gear.

In some aspects, the techniques described herein relate to a power tool, wherein the drivetrain includes a planet carrier, a crankshaft, and an anvil, wherein the planet carrier includes a recess for receiving the anvil, wherein the planet carrier is rotatable relative to the anvil, and wherein the anvil and the crankshaft are coupled together with a spline interface.

Other features and aspects of the disclosure will become apparent by consideration of the following detailed description and accompanying drawings.

### BRIEF DESCRIPTION OF THE DRAWINGS

FIG. 1 is a perspective view of a ratchet tool according to an embodiment of the present disclosure.

FIG. 2 is a partial section view of the ratchet tool of FIG. 1, illustrating a motor and gear assembly.

FIG. 3 is an exploded view of the ratchet tool of FIG. 1, illustrating the motor and gear assembly.

FIG. 4 is a partial section view of the ratchet tool of FIG. 1.

FIG. 5 is a section view of the ratchet assembly of the ratchet tool of FIG. 1.

FIG. 6 is a section view of the ratchet assembly of ratchet tool of FIG. 1.

FIG. 7 is a perspective view of the yoke of the ratchet assembly of FIG. 1.

FIG. 8 is an exploded view of the ratchet assembly of FIG. 1, illustrating an embodiment of a forward-reverse mechanism.

FIG. 9 is a section view of the ratchet assembly of FIG. 1, illustrating the forward- reverse mechanism position.

FIG. 10 is a perspective view of an accessory that is couplable to the ratchet tool.

FIG. 11 is a side section view of the accessory of FIG. 10 coupled to the ratchet tool.

FIG. 12 is a schematic view of a first position, second position, and a third position of the of the ratchet tool of FIG. 1.

FIG. 13A is a flow chart illustrating a process of controlling the motor of the ratchet tool of FIG. 1, according to an example embodiment.

FIG. 13B is a flow chart illustrating a process of controlling the motor of the ratchet tool of FIG. 1, according to another example embodiment.

FIG. 13C is a flow chart illustrating a process of controlling the motor of the ratchet tool of FIG. 1, according to another example embodiment.

FIG. 13D is a flow chart illustrating a process of controlling the motor of the ratchet tool of FIG. 1, according to another example embodiment.

FIG. 14 is a perspective view of a ratchet tool according to an embodiment of the present disclosure.

FIG. 15 is an exploded view of a planet carrier, a crankshaft anvil, and a crankshaft according to an embodiment of the present disclosure.

FIG. 16 is a perspective view of the planet carrier, the crankshaft anvil, and the crankshaft of FIG. 15.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Terms of degree, including “about,” “substantially,” “approximately,” etc., as used herein, are understood by those of ordinary skill to refer to reasonable ranges outside of the given value, for example, general tolerances associated with manufacturing, assembly, and use of the described embodiments.

### DETAILED DESCRIPTION

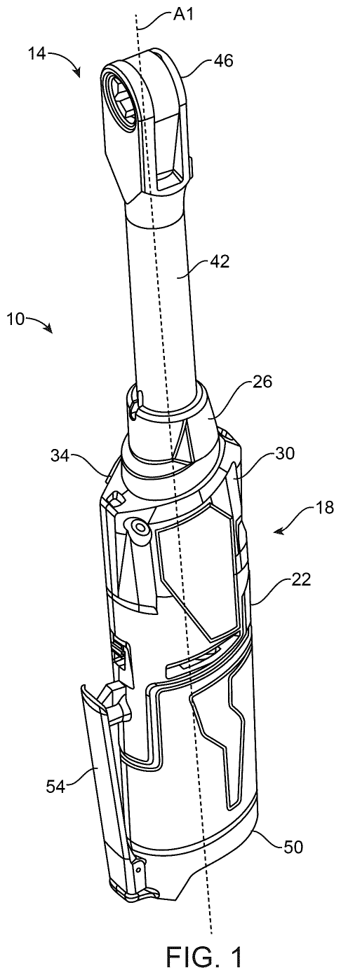

FIG. 1 illustrates an embodiment of a power tool 10 in which aspects of the present disclosure may be implemented. The illustrated power tool 10 (also referred to herein simply as “tool”) 10 is a ratchet tool (e.g., a box ratchet) configured to rotate a fastener in clockwise and counterclockwise directions via a ratchet assembly 14. However, aspects of the present disclosure may be implemented in other types of ratchet tools, as well as other types of power tools, including but not limited to drills, powered screwdrivers, and the like.

The tool 10 includes a housing 18 comprising a shell 22 and a drive housing 26 extends from and is supported by the shell 22. In the illustrated embodiment, a pair of clamshell halves 30, 34 form the shell 22, although the shell 22 may be formed in another manner. A yoke housing 42 is coupled to and extends from the drive housing 26 along a longitudinal axis A1 of the housing 18. The ratchet assembly 14 is positioned at a distal end 46 of the yoke housing 42. As illustrated, the drive housing 26 and yoke housing 42 are formed separately and coupled together. In some embodiments, the drive housing 26 and yoke housing 42 may instead be integrally formed. A battery pack (not shown, but which may be, for instance, a 12-volt battery pack, or a battery pack with another voltage capacity) may be removably coupled to the tool 10 at an end 50 of the housing 18 opposite the distal end 46 (e.g., by sliding the battery pack into the housing 18 along the longitudinal axis A1).

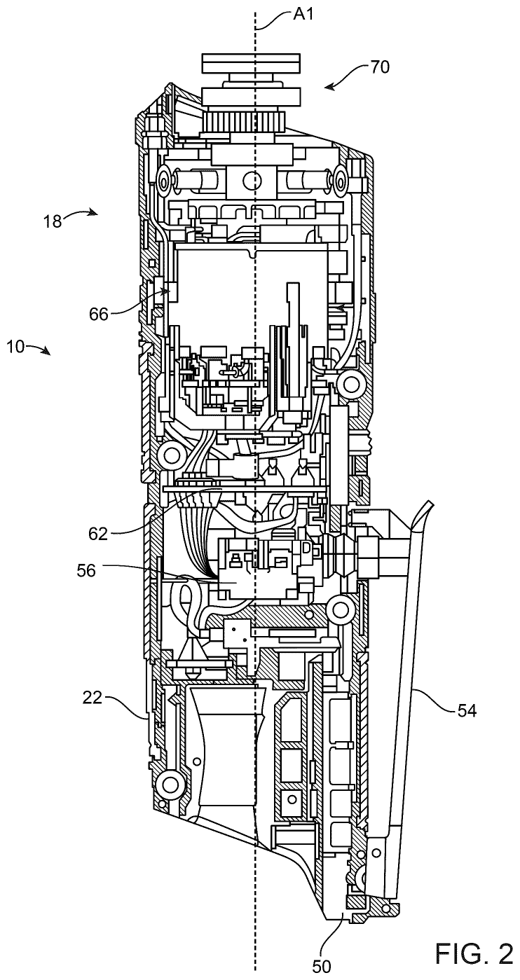

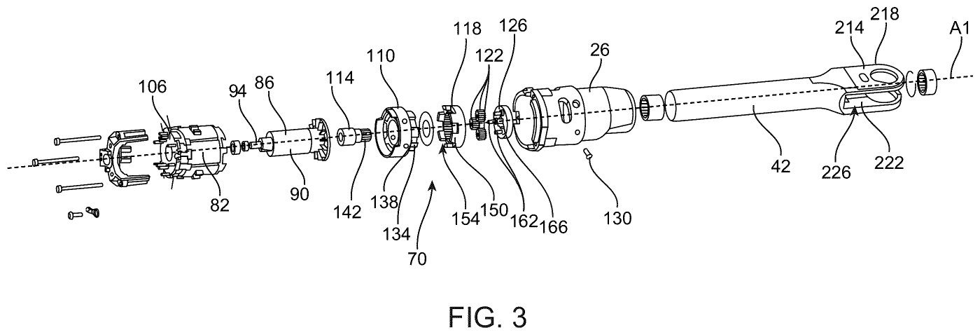

With reference to FIGS. 1 and 2, an actuator 54 (e.g., a trigger paddle) is coupled to the housing 18 proximate the first end 50 of the housing 18 and is manipulable by a user to actuate a switch 56 for controlling operation of the tool 10. More specifically, with reference to FIGS. 2 and 3, the switch 56 is electrically coupled to a first printed circuit board assembly (“PCBA”) 62, which includes electrical and electronic components (e.g., a processor, non-transitory, machine-readable memory, and switching electronics (e.g., MOSFETS, or the like) configured to control operation of a motor 66 of the tool 10.

The illustrated motor 66 is a brushless DC motor and is supported within the housing 18. The motor 66 includes a stator 82 and rotor 86 (FIG. 3). In the illustrated embodiment, the rotor 86 is an internal rotor relative to the stator 82. Specifically, the stator 82 is fixed in the drive housing 26 against rotation and the rotor 86, which includes a rotor body 90, is rotationally supported within the stator 82 such that the rotor 86 is rotatable relative to the stator 82. In other embodiments, the rotor 86 is external relative to the stator 82 (i.e., the motor 66 may be an outer rotor motor). A motor shaft 94 is fixed to the rotor body 90 and is rotatable therewith. In the illustrated embodiment, a second PCBA 106 is supported adjacent the stator 82. The second PCBA 106 includes a sensor (e.g., a position sensor such as a Hall effect sensor) to ascertain information about the motor 66 which is provided to the first PCBA 62. The first PCBA 62 and the second PCBA 106, together with the electrical and electronic components incorporated thereon, may thus define a controller configured to control operation of the power tool 10 by executing the steps and processes described herein. It should be understood that the controller may include other combinations and arrangements of motor control electronics. For example, the components on the PCBA 62 may be incorporated on to the second PCBA 106, and the PCBA 62 may be omitted.

With continued reference to FIG. 3, a gear assembly 70 is supported in the drive housing 26 and is coupled to the motor shaft 94 to receive a rotational input and torque from the motor shaft 94. The gear assembly 70 and the ratchet assembly 14 may thus collectively define a drivetrain of the tool 10. As illustrated, the gear assembly 70 is a planetary transmission. The gear assembly 70 includes an anti-rotation collar 110, a pinion 114, a ring gear 118, and a plurality of planetary gears 122 coupled to a carrier 126. In other embodiments, other types of gear assemblies may be used, or the gear assembly 70 may be omitted altogether.

The anti-rotation collar 110 is coupled to the drive housing 26 and is engaged by the anti-rotation pin 130 which is at least partially disposed in the drive housing 26 and the anti-rotation collar 110, thereby preventing rotation of the anti-rotation collar 110 relative to the drive housing 26. In other embodiments, the anti-rotation collar 110 may be press-fit in the drive housing 26 and/or contain a keyway in which a key is disposed that engages the drive housing 26 to prevent rotation of the anti-rotation collar 110. In still other embodiments, the anti-rotation collar 110 may be coupled to the drive housing 26 by fasteners. In yet other embodiments, projections and recesses from the ring gear 118 may engage the drive housing 26. The anti-rotation collar 110 includes a plurality of projections 134 that extend along the tool axis A1 away from the rotor 86 and are spaced evenly about the circumference of the anti-rotation collar 110. The projections 134 define recesses 138 therebetween.

The pinion 114 is coupled to the motor shaft 94 for rotation with the motor shaft 94. The pinion 114 defines teeth 142 that engage the planetary gears 122 to transmit the rotational motion of the motor shaft 94 to the gear assembly 70, and thereby, the ratchet assembly 14. The ring gear 118 is disposed in the drive housing 26 adjacent to and engaging the anti-rotation collar 110. In that regard, the ring gear 118 defines a plurality of projections 150 and recesses 154 therebetween spaced equidistantly about the circumference of the ring gear 118 that extend along the tool axis A1 toward the motor 66. The projections 150 and recesses 154 of the ring gear 118 align with and engage the recesses 138 and projections 134 of the anti-rotation collar 110 thereby preventing rotation of the ring gear 118 relative to the anti-rotation collar 110 and the drive housing 26. In other embodiments, the ring gear 118 may be press-fit within the drive housing 26 thereby preventing rotation of the ring gear 118 relative to the drive housing 26. The ring gear 118 defines a gear portion 158 on an interior diameter of the ring gear 118.

The planetary gears 122 are disposed in the drive housing 26 radially within the ring gear 118. The planetary gears 122 are disposed around and engage the teeth 142 of the pinion 114, and are rotationally supported on the carrier 126 by shafts 162 extending from the carrier 126 parallel to the tool axis A1 toward the motor 66. In the illustrated embodiment, the tool 10 includes three planetary gears 122, although other quantities may be used instead. The carrier 126 is rotatable relative to the drive housing 26 and includes a splined aperture 166.

The planetary gears 122 engage the pinion 114 and the ring gear 118 such that rotation of the pinion 114 results in rotation of the planetary gears 122. Engagement of the planetary gears 122 with the ring gear 118 results in the planetary gears 122 orbiting along the inner periphery of the ring gear 118, causing the carrier 126 to rotate about the axis A1, thus transferring a rotational motion of the motor shaft 94 to the carrier 126 at a reduced speed and increased torque. In some embodiments, the tool 10 may include additional gear stages to further reduce the rotational speed and increase the torque output of the tool 10. In yet other embodiments, the gear assembly 70 may be configured in other ways.

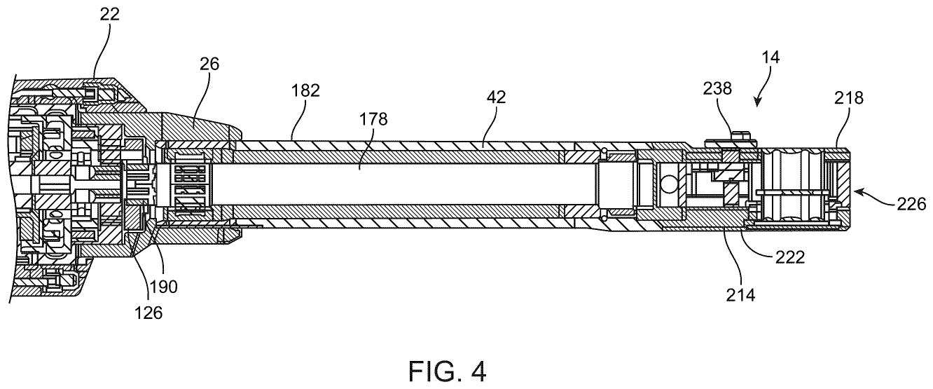

With reference to FIGS. 4-6, the tool 10 includes a crankshaft 178 is at least partially disposed in an elongated extension portion 182 of the yoke housing 42. As illustrated, the crankshaft 178 includes a splined portion 190 received by the splined aperture 166 of the carrier 126 such that the crankshaft 178 is rotatable about the tool axis A1 with the carrier 126. In other embodiments, the crankshaft 178 may be coupled to the carrier 126 in another manner.

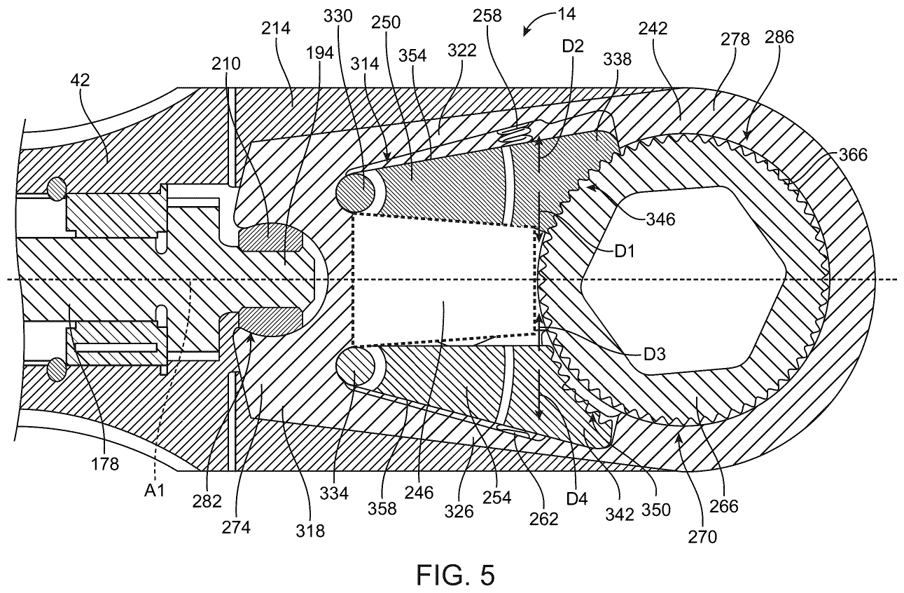

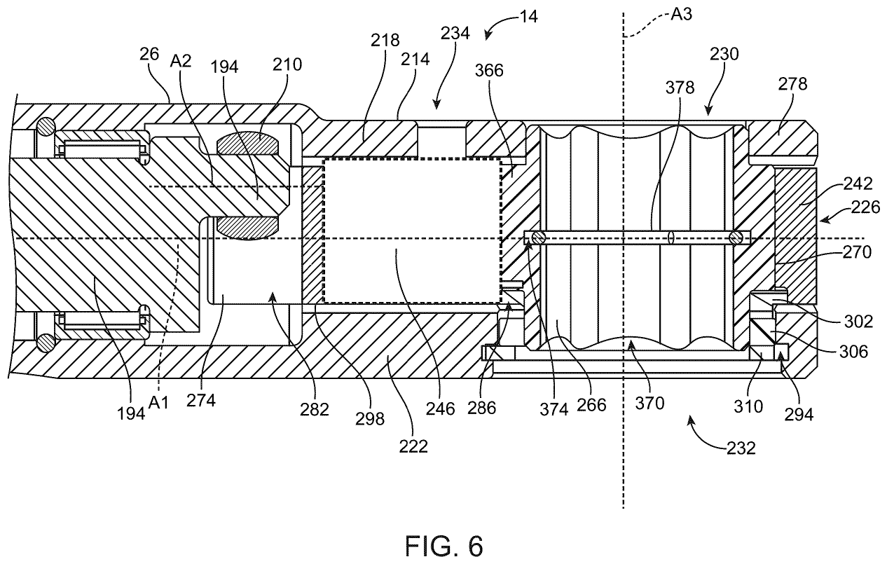

Best illustrated in FIGS. 5-6, the crankshaft 178 has a coupling portion 194 that defines a coupling axis A2 radially offset from the axis A1, such that the coupling portion 194 is eccentrically positioned relative to the remainder of the crankshaft 178. The coupling portion 194 supports a spherical bearing 210. The bearing 210 engages and drives the ratchet assembly 14 to reciprocate the ratchet assembly 14 in response to rotation of the crankshaft 178, as described below.

With continued reference to FIGS. 4-6, the ratchet assembly 14 is shown in greater detail. The ratchet assembly 14 is pivotally coupled to a head portion 214 of the yoke housing 42. The ratchet assembly 14 is pivotable relative to the yoke housing 42 about a fastening axis A3 (FIG. 6), which is perpendicular to the tool axis A1, although other angular relationships between the tool axis A1 and the fastening axis A3 may be present in other embodiments. The head portion 214 includes upper and lower flanges 218, 222 that define a cavity 226 therebetween. Each of the upper and lower flanges 218, 222 includes a fastening hole 230, 232 through which a fastener or an accessory can be inserted to engage the ratchet assembly 14. The upper flange 218 also includes a hole 234 through which a directional knob 238 (i.e., a selector) of the ratchet assembly 14 is inserted.

The ratchet assembly 14 includes a yoke 242, a forward-reverse assembly 246 (illustrated schematically in FIGS. 5 and 6), a left pawl 250 and a right pawl 254, biasing members (e.g., a first biasing member 258 and a second biasing member 262), and a drive 266, which, in the illustrated embodiment, includes a splined outer periphery 270 configured to interface with the pawls 250, 254, as described in greater detail below.

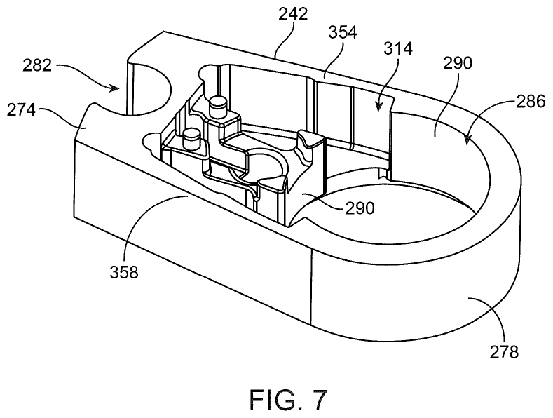

Referring to FIG. 7, the yoke 242 defines an engagement portion 274 and an opposite, rounded end portion 278. The engagement portion 274 includes a recess 282 having a semi-circular cross-section that receives the coupling portion 194 of the crankshaft 178 and the bearing 210. The yoke 242 further defines a fastening hole 286 having a plurality of surfaces 290 that are substantially concentric with the rounded end portion 278. Returning to FIGS. 5 and 6, the drive 266 is received in the fastening hole 286. At least one groove 294 concentric with the fastening hole 286 is positioned in the ratchet portion 214 of the yoke housing 42 adjacent a bottom face 298 of the yoke 242 and is configured to receive and retain retention structures (e.g., a two-turn wave spring 302, a friction plate 306, and a retaining ring 310). The retention structures may instead include a wave washer or other structures to retain the drive and maintain rotational position of the drive. A cavity 314 extends from a top face 318 of the yoke 242 and is configured to receive the left and right pawls 250, 254, the forward-reverse assembly 246, and the first and second biasing members 258, 262. The cavity 314 defines outer walls 322, 326 extending between the engagement portion 274 and the rounded end portion 278.

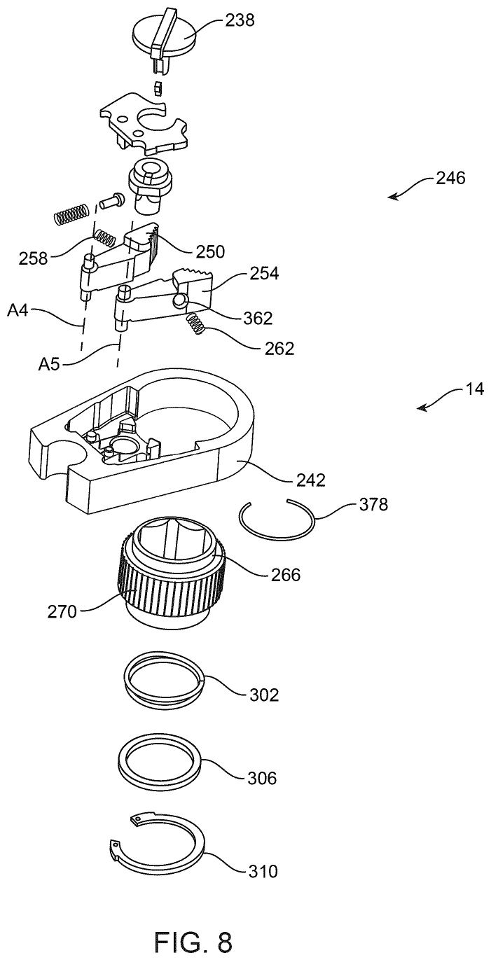

The left pawl 250 and the right pawl 254 are pivotally coupled to the yoke 242, with each pawl 250, 254 rotatable about a pawl rotational axis (e.g., a first pawl rotational axis A4, a second pawl rotational axis A5, shown in FIG. 8) relative to the yoke 242. In that regard, the left pawl 250 is rotatable about the first pawl rotational axis A4 in a first direction D1 toward the drive 266 and a second direction D2 away from the drive 266, and the right pawl 254 is rotatable about the second pawl rotational axis A5 in a first direction D3 toward the drive 266 and a second direction D4 away from the drive 266. Each of the left pawl 250 and the right pawl 254 define a coupling portion 330, 334 pivotally coupled to the yoke 242 and an opposite engagement portion 338, 342 that defines pawl teeth 346, 350. Outer walls 354, 358 extend between the coupling portion 330, 334 and the engagement portion 338, 342 of each of the left pawl 250 and the right pawl 254. In some embodiments, a bore 362 (FIG. 8) extends into the outer walls 354, 358 of the left and right pawls 250, 254.

The drive 266 is rotatably supported in the fastening hole 286 of the yoke 242, at least partially between the left and right pawls 250, 254, and rotates about the fastening axis A3. The splined outer periphery 270 of the drive 266 defines a plurality of teeth 366 positioned circumferentially about the outer periphery 270. The drive 266 further defines an insertion hole 370. As illustrated, the insertion hole 370 has a hexagonal cross-section. In other embodiments, the insertion hole 370 may have a different cross section (e.g., square, Torx, etc.). A groove 374 extends about the circumference of the insertion hole 370 and receives an accessory retention spring 378 therein. The accessory retention spring 378 may be an O-ring made of a resilient material. The accessory retention spring 378 extends at least partially into the insertion hole 370 (in a radially inward direction) and may engage an accessory to frictionally retain the accessory within the insertion hole 370. In other embodiments, the drive 266 may include detent balls or other retention structures configured to maintain the coupled relationship of an accessory and the drive 266.

Returning to FIGS. 5 and 8, the first and second biasing members 258, 262 engage the left and right pawls 250, 254 and bias the left and right pawls 250, 254 toward the drive 266. In the illustrated embodiment, the left and right pawls 250, 254 are compression springs that are supported in the bore 362 (the bore in the left pawl 250 is substantially identical to the bore 362 of the right pawl 254, shown in FIG. 8) of the left and right pawls 250, 254 and engage the outer walls 322, 326 of the yoke 242 to bias the left and right pawls 250, 254 toward the drive 266. Specifically, the first biasing member 258 supported in the bore of the left pawl 250 imparts a biasing force on the left pawl 250 in the first direction D1, resulting in a moment about the first pawl rotational axis A 4 in the first direction D1. The second biasing member 262 is supported in the bore 362 of the right pawl 254 and imparts a biasing force on the right pawl 254 in the first direction D3, toward the drive 266, resulting in a moment (i.e., a third moment) about the second pawl rotational axis A5. In another embodiment, the first and second biasing members 258, 262 may be torsion springs that engage the left and right pawls 250, 254 and the yoke 242 to bias the pawls 250, 254 toward the drive 266. In yet another embodiment, the first and second biasing members 258, 262 may be tension springs coupled to the left and right pawls 250, 254 that bias the left and right pawls 250, 254 toward the drive 266. In still other embodiments, other types of springs, or another structure that can impart a moment on the left and right pawls 250, 254 may instead be used.

The forward-reverse assembly 246 is supported in the cavity 314 of the yoke 242 between the left and right pawls 250, 254. The forward-reverse assembly 246 is configured to selectively disengage the left and right pawls 250, 254 with the drive 266 for user selection of the operational direction (i.e., the rotational direction in which tightening or loosening of a fastener is accomplished) of the ratchet assembly 14.

With reference to FIGS. 5, 6, and 9, engagement of the right pawl 254 with the drive 266 and positioning of the ratchet assembly 14 and the coupling portion 194 of the crankshaft 178 are illustrated in more detail. In response to actuation of the switch 56 and the motor 66, the crankshaft 178, and the coupling portion 194 with it, are rotated about the tool axis A1. Upon rotation of the coupling portion 194 about the tool axis A1, engagement of the bearing 210 with the yoke 242 rotates the ratchet assembly 14 in a periodic, or alternating, clockwise-and-counterclockwise about the fastening axis A3.

As the ratchet assembly 14, and the left and right pawls 250, 254 with it, are rotated in a periodic pattern, one of the left or right pawl 250, 254, the driving pawl, depending on the position of the forward-reverse assembly 246, will be engaged with the drive 266 as a result of the moment applied by the first or second biasing member 258, 262, while the other of the left and right pawls 250, 254, the disengaged pawl, will be biased away from and out of engagement with the drive 266 by the forward-reverse assembly 246.

In an exemplary operation of the tool 10, rotation of the ratchet assembly 14 in a first direction (e.g., counter-clockwise) about the fastening axis A3 results in driving engagement of the driving pawl (e.g., the right pawl 254) with the drive 266 (i.e., the pawl teeth 350 engage and push the teeth 366 of the drive 266) that rotates and advances the drive 266 about the fastening axis A3 and rotation of the ratchet assembly 14 in the opposite, second direction (e.g., clockwise) about the fastening axis A3 results in sliding engagement of the driving pawl (e.g., the right pawl 254), whereby the pawl teeth 350 of the driving pawl 254 slide over the teeth 366 of the drive 266 and the drive 266 remains stationary.

In response to rotation of the ratchet assembly 14 and engagement of the left or right pawl 250, 254 with the drive 266, a frictional force between the drive 266 and the left or right pawl 250, 254 is induced, which imparts a frictional moment on the left or right pawl 250, 254 in the first direction D1, D3 toward the drive 266 about the left or right pawl rotational axis A4, A5. That is, when the left pawl 250 is engaged with the drive 266, the frictional force imparted by the spline teeth 366 on the left pawl 250 results in a frictional moment about the left pawl rotational axis A4 in the first direction D1 toward the drive 266. When the right pawl 254 is engaged with the drive 266, the frictional force imparted by the spline teeth 366 on the right pawl 254 results in a frictional moment about the right pawl rotational axis A5 in the first direction D3 toward the drive 266. Rotation of the drive 266 or the ratchet assembly 14 will relieve the frictional force of the drive 266 on the pawls 250, 254.

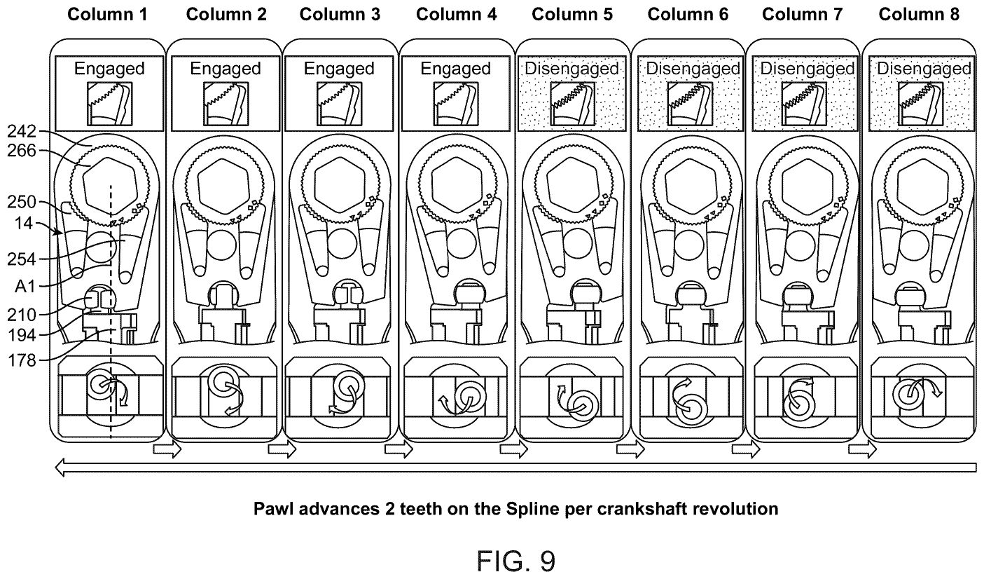

With continued reference to FIG. 9, an exemplary rotational operation sequence of the tool 10 is illustrated in further detail. The first column illustrates an exemplary starting rotational position of the crankshaft 178 and ratchet assembly 14. As the crankshaft 178 and coupling portion 194 begin rotation about the tool axis A1 from the initial rotational position, the ratchet assembly 14 is pivoted in a first direction (e.g., counterclockwise) about the fastening axis A3. As the coupling portion 194 rotates through 180 degrees (columns 2, 3, and 4), the bearing 210 engages the yoke 242 and continues to rotates the ratchet assembly 14 in the first direction. The pawl teeth 350 of the right pawl 254 are engaged with the teeth 366 of the drive 266 while the left pawl 250 is biased out of engagement with the drive 266 by the forward-reverse assembly 246. Engagement of the pawl teeth 350 with the teeth 366 of the drive 266 rotationally advances the drive 266 relative to the yoke housing 42. As the crankshaft 178 and coupling portion 194 pass through 180 degrees of rotation (columns 4 to 5), the ratchet assembly 14 reaches the end of the rotational stroke as a result of the position of the coupling portion 194, and the ratchet assembly 14 begins rotation in the opposite, second direction (e.g., clockwise). As the ratchet assembly 14 proceeds in the second direction (columns 5-8), the pawl teeth 350 of the right pawl 254 slide along the teeth 366 of the drive 266 without engaging and advancing the drive 266 in the second direction (e.g., counterclockwise). As the crankshaft 178 completes its 360-degree rotation, the ratchet assembly 14 completes a stroke in the second direction (clockwise). At the completion of rotation of the crankshaft 178 and resulting completion of the ratchet assembly stroke, the right pawl 254 has advanced to a position (left triangular and left square indicators in column 8 of FIG. 9) that is at least one spline tooth (e.g., two spline teeth, four spline teeth, or another number of spline teeth) from the initial starting position (right triangular and square indicators in column 8 of FIG. 9) of the right pawl 254 relative to the drive 266. In other embodiments, the ratchet assembly 14 may be configured such that a greater or smaller advancement of the right pawl 254 relative to the drive 266 may occur.

As illustrated, the right pawl 254 is biased into engagement with the drive 266 via the second biasing member 262. The left pawl 250 may instead be biased into engagement with the drive 266, in which embodiment, the engagement and disengagement of the left pawl 250 with the drive 266 would be reversed for the rotational positions of the crankshaft 178 illustrated in FIG. 9. That is, the left pawl 250 would be disengaged at the rotational position of the crankshaft 178 shown in columns 1-4 of FIG. 9 and would be engaged for rotational positions of the crankshaft 178 shown in columns 5-8 of FIG. 9.

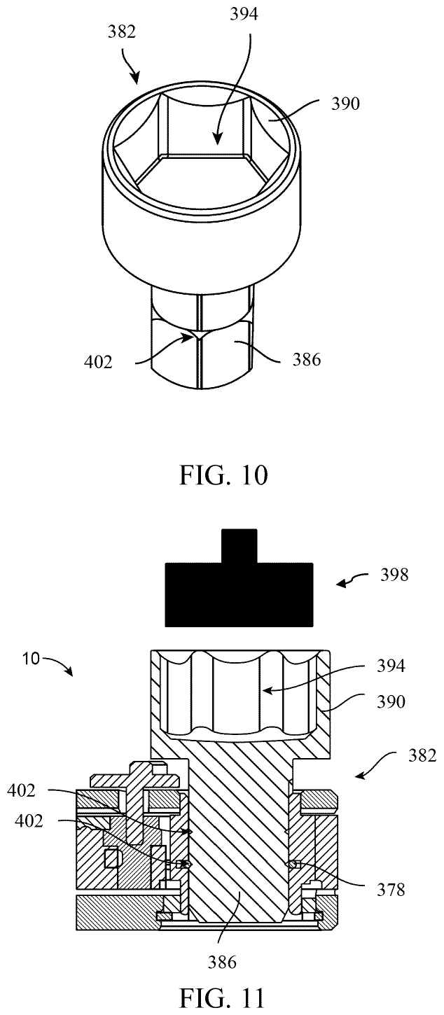

FIG. 10 illustrates an embodiment of an accessory in the form of a socket 382 having a coupling portion 386 configured to be received in the insertion hole 370 of the drive 266. In the present embodiments, the coupling portion 386 is illustrated as having a hexagonal cross-sectional profile, however other cross-sectional profiles may be used instead. An adapter portion 390 extends from the coupling portion 386. The socket 382 has an adapter portion 390 that defines a recess 394 having a hexagonal cross-section configured to receive a hexagonal head of a fastener 398, although the recess 394 could receive other fastener heads such as appropriately sized square and Torx heads. In other embodiments, the recess 394 may have other cross-sectional profiles. In one embodiment, the recess may have a cross-section that is a twelve-point double hexagon.

As shown in FIG. 11, the socket 382 may be inserted into the drive 266 from either the top or the bottom in some embodiments. The first groove 402 receives the accessory retention spring 378. When the first groove receives the accessory retention spring 378, the accessory is at a position that provides additional reach, that is, facilitates engagement of the accessory with a fastener that is recessed below an adjacent surface. When the accessory is inserted in the first direction (i.e., from the bottom of the tool), the accessory may be further inserted such that the second groove receives the accessory retention spring 378 and the accessory is fully inserted.

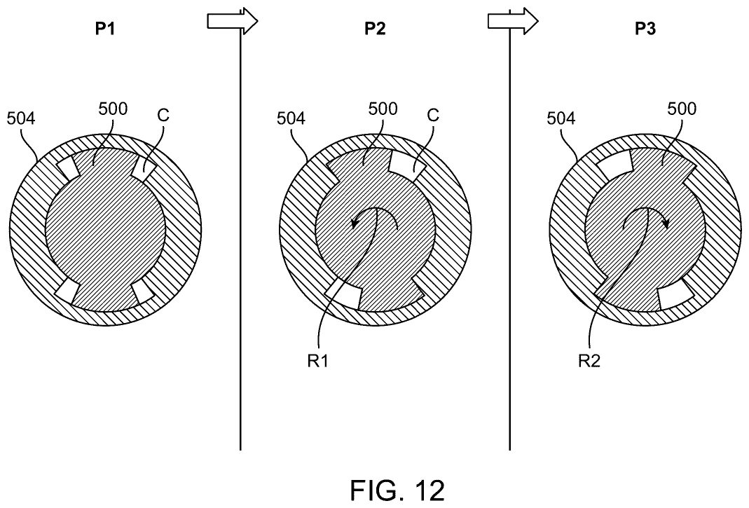

The tool 10 includes clearances at interfaces between components when fully assembled. As a non-limiting example, clearances may be present at an interface between the housing 18 and the stator 82, an interface between the pinion 114 and the plurality of planetary gears 122, an interface between the planet gears 122 and the ring gear 118, an interface between the ring gear 118 and the anti-rotation collar 110, an interface between the carrier 126 and the gear portion 190 of the crankshaft 178, an interface between the bearing 210 and the yoke 242, an interface between the yoke 242 and the pawls 250, 254, an interface between the pawl teeth 346, 350 of the pawls 250, 254 and the splined outer periphery 270 of the drive 266, an interface between the drive 266 and the socket 382, and/or an interface between the socket 382 and the fastener 398. Illustrated schematically in FIG. 12, the sum of these clearances results in a clearance region C, in which an input 500 of the tool 10 may rotate relative to an output 504 of the tool 10.

In the illustrated embodiment, the motor 66 defines the input 500, and the fastener 398 defines the output 504. As such, the rotor 86 of the motor 66 may rotate to a limited extent relative to the fastener 398 within the clearance region C. Depending on the relative positions of the various components in the drive train of the tool 10 between the input 500 and the output 504, portions of the clearance region C may be located in either rotational direction of the input 500. This is depicted schematically in FIG. 12 in column P1.

The controller of the tool 10 may control the input 500 (i.e., the motor 66) to rotate in a first direction (e.g., R1), to take up any of the clearance region C in the first direction R1, as illustrated in column P2. In response to a particular condition (e.g., a predetermined amount of time elapsing, a stall of the motor 66 being detected, or a specified user input), the controller may then reverse the direction of rotation of the input 500 to rotate in a second direction (e.g., R2).

After initially rotating the input 500 in the first direction R1, the entire clearance region C is shifted between the input 500 and the output 504 in the second rotational direction R2. This provides the maximum available amount of angular distance for the input 500 to accelerate in the second rotational direction R2 before engaging with and being subject to torque load from the output 504, as illustrated in column P3. By accelerating through the clearance region C without load, the input 500 can more rapidly increase its rotational speed and inertia, thereby advantageously delivering a higher peak torque to the output 504 once the clearance region C is taken up. Because the output direction (i.e. fastening direction) of the tool 10 is determined by the position of the directional knob 238 (rather than the rotational direction of the motor 66), the tool 10 continues to tighten or loosen the fastener 398, regardless of the input 500 reversing direction.

It is worth nothing that although FIG. 12 illustrates the input 500 subsequently being rotated in the second direction R2 after being rotated in the first direction R1, the input 500 can be rotated in the first direction R1 after being rotated in the second direction R2. In other words, the process described above with respect to maximizing the clearance region C can be achieved by rotating the tool input 500 in the first direction R1 after being rotated in the second direction R2

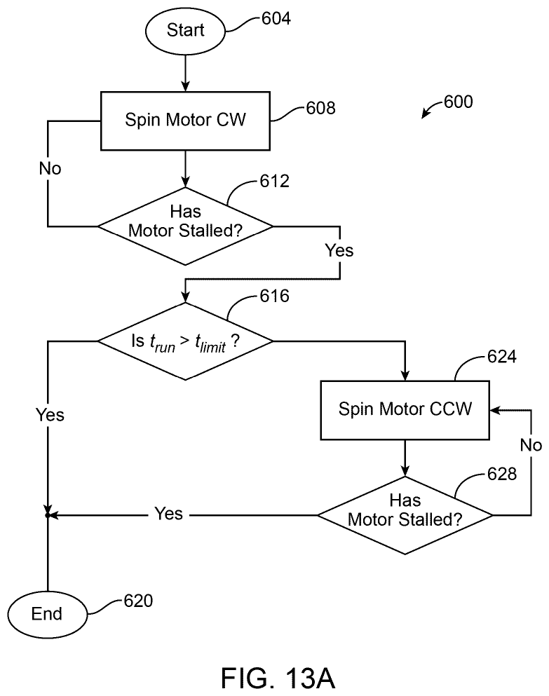

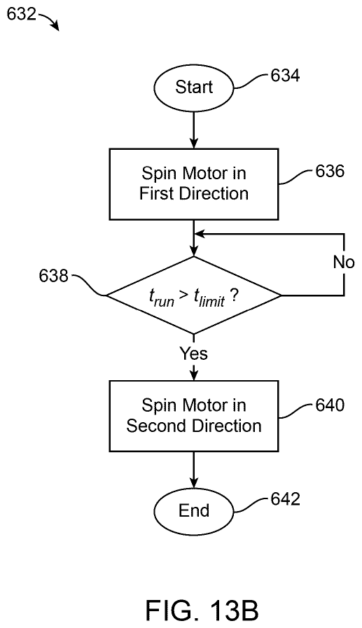

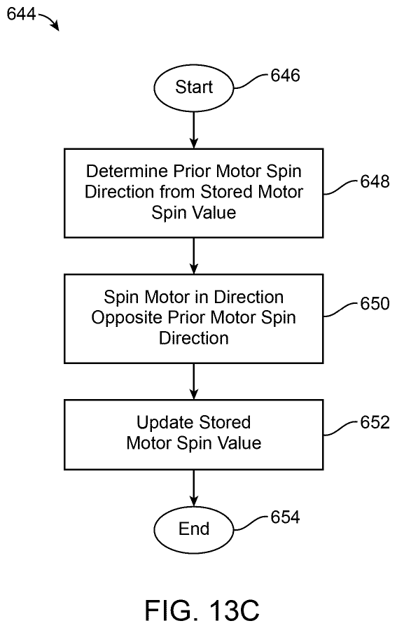

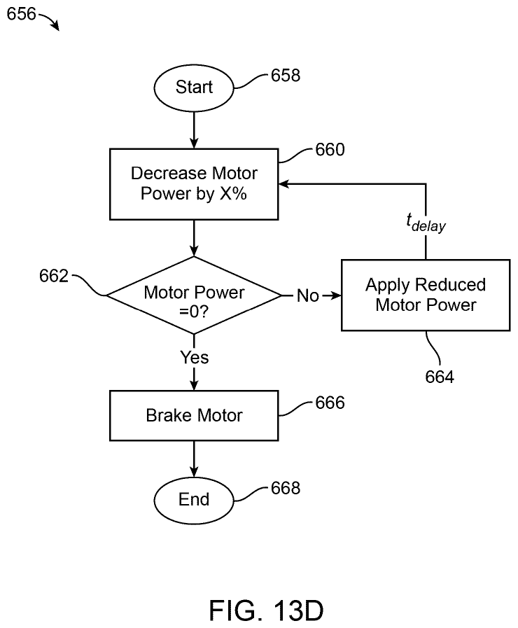

An exemplary method or process 600 of operating a power tool, such as the tool 10, is depicted in a flow chart in FIG. 13A. The process 600, which may be implemented as algorithms/instructions retrieved from memory and executed by the processor of the controller, may include additional steps or functions not specifically discussed herein (e.g., reading a state-of-charge to confirm the tool 10 has sufficient power, reading a temperature to confirm to tool 10 can be operated safely, etc.).

At block 604, the controller receives an input starting the process 600. The input may be, for example, a signal from the switch 56 in response to the user depressing the actuator 54. After receiving the input, the controller energizes the motor 66 to spin in the first direction R1 at block 608. The controller may also start a timer tᵣᵤₙ upon receiving the input. Operation of the tool 10 then proceeds as described above to drive the fastener 398.

At block 612, as operation of the tool 10 proceeds, the controller identifies whether the motor 66 has stalled. To determine whether the motor 66 has stalled, the controller may receive and monitor inputs from one or more sensors, such as a motor current sensor, a torque sensor, a rotation sensor, or the like. The controller may determine that the motor 66 has stalled if, for example, the motor current sensor indicates a spike in current while rotation of the rotor 86 slows or stops.

If the motor 66 has not stalled, then the process 600 loops back to block 608 and operation of the tool 10 continues normally. Alternatively, if the controller determines that the motor 66 has stalled, the process 600 proceeds to block 616, where the controller determines whether a time duration tᵣᵤₙ, which was started at the block 604, has achieved a time limit tₗᵢₘᵢₜ. In some embodiments, the time duration tᵣᵤₙ is the time since the switch 56 was activated. In other embodiments, the time duration tᵣᵤₙ is the running time of the motor 66.

If the time duration as tᵣᵤₙ is greater than the time limit tₗᵢₘᵢₜ, the process 600 proceeds to the block 620, where the process 600 ends. If the time duration as tᵣᵤₙ is less than the time limit tₗᵢₘᵢₜ, the process 600 proceeds to block 624, where the controller reverses the motor 66 to rotate in the second direction R2. By operating the motor 66 in the second direction R2 after the motor 66 has been operating in the first direction R1, the motor 66 is able to accelerate through the clearance region C as described above with respect to FIG. 12. This may allow the tool 10 to deliver a greater peak torque (e.g., to break away a stuck fastener or deliver a higher final tightening torque, for example).

At block 628, the controller again determines whether the motor 66 has stalled while operating in the second direction R2. If the motor 66 has not stalled, then the process 600 loops back to block 624 and the motor 66 continues operating in the second direction R2 until the user releases the actuator 54 or until the controller determines that the motor 66 has stalled. Upon identifying that the motor 66 has stalled, the process 600 proceeds to the block 620, where the controller may de-energize the motor 66.

In some embodiments, the controller may not reverse the motor 66 based on a detected stall but may instead reverse a predetermined time period after actuation of the switch 56. For example, FIG. 13B illustrates another method or process 632 of operating a power tool, such as the tool 10. At block 634, the controller receives an input starting the process 632. The input may be, for example, a signal from the switch 56 in response to the user depressing the actuator 54. After receiving the input, the controller energizes the motor 66 to spin in the first direction R1 at block 636. The controller also starts a timer tᵣᵤₙ upon receiving the input. At block 638, the controller determines whether tᵣᵤₙ has achieved a time limit tₗᵢₘᵢₜ. Once tᵣᵤₙ reaches tₗᵢₘᵢₜ, the controller automatically reverses the motor 66 to operate in the second rotational direction R2 at block 640. The time limit tₗᵢₘᵢₜ is sufficient to take up any clearance in the first direction R1, and may be between 20 and 500 milliseconds in some embodiments, between 20 and 250 milliseconds in some embodiments, between 20 and 100 milliseconds in some embodiments, or between 30 and 50 milliseconds in some embodiments. In some embodiments, this automatic reversing functionality may be selectively enabled by the user (e.g., via a mode button, a specified sequence of depressing the actuator 54, or any other suitable means).

By operating the motor 66 in the second direction R2 at block 640 after the motor 66 has been operated briefly in the first direction R1, the motor 66 is able to accelerate through the clearance region C as described above with respect to FIG. 12. This may allow the tool 10 to deliver a greater peak torque (e.g., to break away a stuck fastener or deliver a higher final tightening torque, for example). The motor 66 continues to operate in the second direction R2 until the user releases the actuator 54 at block 642. Open a subsequent actuation of the actuator 54, the process 632 repeats.

In yet other embodiments, the controller may reverse the operating direction of the motor 66 upon each actuation of the switch 56. For example, FIG. 13C illustrates another method or process 644 of operating a power tool, such as the tool 10. At block 646, the controller receives an input (e.g., a signal from the switch 56 in response to the user depressing the actuator 54) starting the process 644. After receiving the input, the controller determines a prior motor spin direction of the motor 66 from a motor spin value stored in the memory of the controller at block 648. For example, the controller may receive a first motor spin value if the motor 66 was last operated in the first direction R1 or a second motor spin value if the motor 66 was last operated in the second direction R2. Next, at block 650, the controller operates the motor 66 in a direction opposite the last operating direction of the motor, as indicated by the stored motor spin value. That is, if the motor 66 was last operated in the first direction R1, the controller will operate the motor in the second direction R2, and vise versa.

By operating the motor 66 in the direction opposite the last operating direction, the motor 66 is able to accelerate through the clearance region C as described above with respect to FIG. 12. This may allow the tool 10 to deliver a greater peak torque (e.g., to break away a stuck fastener or deliver a higher final tightening torque, for example). The motor 66 continues to operate until the user releases the actuator 54, and at block 652 the controller updates the stored motor spin value based on the direction in which the motor 66 was just operated. The process 644 ends at block 654. Open a subsequent actuation of the actuator 54, the process 644 repeats, such that the motor 66 reverses direction upon each actuation of the actuator 54.

FIG. 13D illustrates another process or method 656 of operating a power tool, such as the tool 10. The illustrated process 656 provides for smoother motor deceleration and braking and, in some embodiments, may be incorporated into any of the processes 600, 632, 644 described herein. For example, the process 656 may be used to slow down and stop the motor 66 prior to the motor automatically reversing direction, and/or to slow down and stop the motor 66 when the user releases the actuator 54.

With reference to FIG. 13D, the illustrated process 656 begins with an input signal at block 658, which may be a signal received from the switch 56 in response to the user releasing the actuator 54 or a signal generated by the controller (e.g., when the controller determines it is time to reverse the motor 66 as discussed above in connection with the process 600 or the process 632). Next, at block 660, the motor power is decreased by a predetermined amount X %. For example, in some embodiments, X % may between 5%-10%. The controller determines if this reduction in motor power results in the motor power being set to zero at block 662. If not, the reduced motor power is applied at block 664 and the motor 66 operates at the reduced power for a predetermined time period t_{delay}. The process 656 then loops back to block 660, such that the controller repeatedly decreases the motor power over time. For example, in some embodiments, the time period t_{delay} is 1 millisecond. In some such embodiments, the process 656 reduces the motor power by 10% or less per 1 ms until the motor power is set to zero. In some such embodiments, the process 656 reduces the motor power by 5% or less per 1 ms until the motor power is set to zero.

Once the motor power is set to zero, the process 656 proceeds to block 666 and initiates a motor braking operation. To brake the motor 66, the controller may hold the low side FETs ON and the high side FETs OFF to thereby apply low-side braking (effectively creating a short circuit across the motor terminals). This forces the motor 66 to quickly stop. The process then ends at block 668. By gradually ramping down motor power at blocks 660, 662, and 664 before applying motor braking at block 666, the motor 66 begins to slow before the braking is applied, and the deceleration of the motor 66 due to braking is therefore made less abrupt. The process 656 may therefore be implemented by the controller to result in a smoother feel when operating the power tool 10.

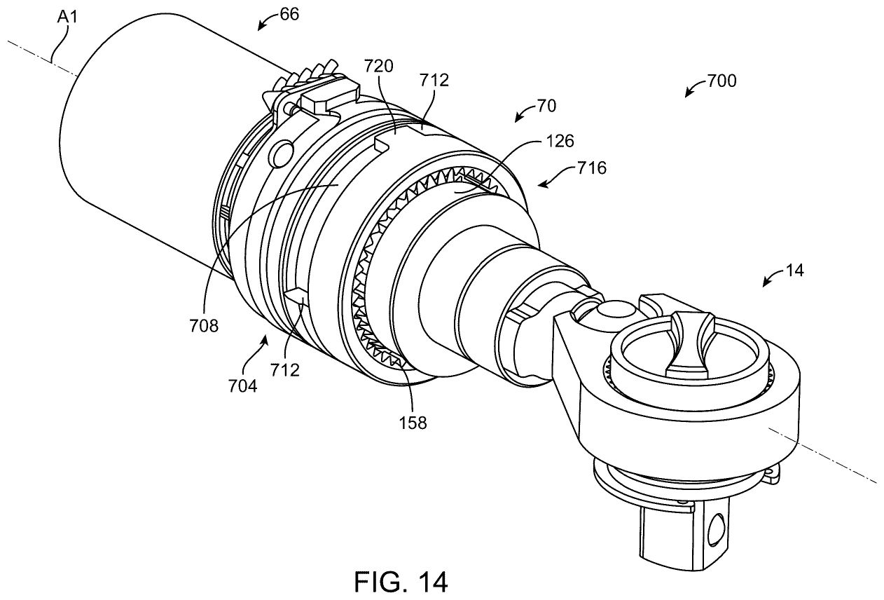

FIG. 14 illustrates another embodiment of a tool 700 with like features as the tool 10 being identified with like reference numerals. The tool 700 is like the tool 10 and therefore only differences will be discussed. The tool 700 includes a collar 704 that is coupled to the housing (not shown). The collar 704 includes an arcuate slot 708 defined between shoulders 712. The tool 700 includes a ring gear 716 that interfaces with the collar 704. The ring gear 716 includes a projection 720 that extends in a direction parallel the longitudinal axis A1. The projection 720 is received within the arcuate slot 708 of the collar 704. Upon rotation of the motor 66, the ring gear 716 may rotate relative to the collar 704 (e.g., a housing) a limited extent until the projection 720 reaches the end of the arcuate slot 708. When the ring gear 716 is free to rotate, the gear assembly 70 is effectively disabled. That is, the motor 66 just drives the rotation of the ring gear 716, rather than the carrier 126. The relative movement of the ring gear 716 relative to the collar 704 introduces additional clearance in the drivetrain. In the illustrated embodiment, the ring gear 716 may rotate approximately 90 degrees until the projection 720 contacts the shoulders 712. In other embodiments, the angular span of the arcuate slot 708 may be increased or decreased and the size of the projection 720 may be increased or decreased to provide the desired amount of rotation of the ring gear 716. That is, the ring gear 716 may rotate more than 90 degrees or less than 90 degrees depending on the angular span of the arcuate slot 708 and the size of the projection 720. The relative movement between the collar 704 and the ring gear 716 contributes to the clearance region C (FIG. 12).

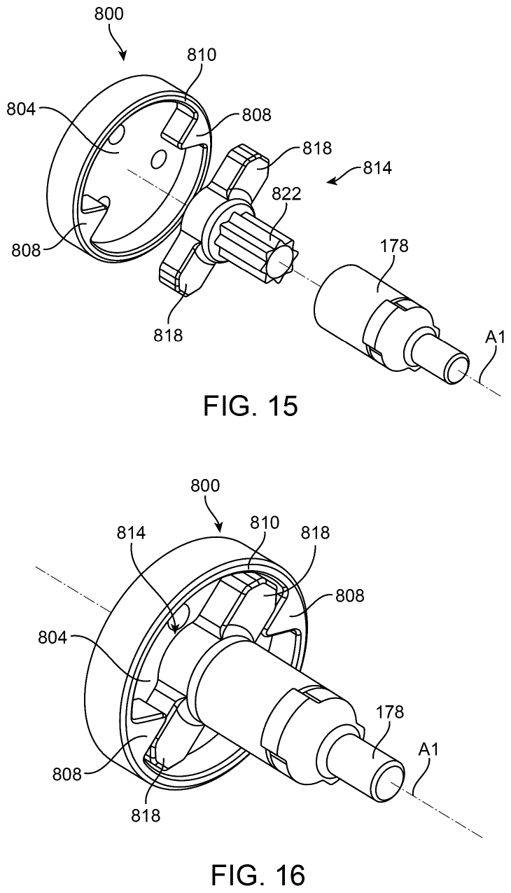

FIGS. 15 and 16 illustrate another embodiment of a planet carrier 800 that is interchangeable with the planet carrier 126. The planet carrier 800 is like the planet carrier 126 and therefore only differences will be discussed. The planet carrier 800 includes a recess 804 with a pair of shoulders 808. The recess 804 includes a depth relative to a periphery 810 of the planet carrier 800. The drivetrain includes a crankshaft anvil 814 that includes a pair of lugs 818. The crankshaft anvil 814 is received within the recess 804 of the planet carrier 800. In the illustrated embodiment, the crankshaft anvil 814 is axially fixed along the longitudinal axis A1. The lugs 818 define a thickness that is approximately the same value as the depth of the recess 804. The crankshaft anvil 814 includes a splined portion 822 configured to interface with the crankshaft 178. In other words, the crankshaft anvil 814 and the crankshaft 178 are coupled together with a spline interface. In other embodiments, the crankshaft anvil 814 and the crankshaft 178 are integrated (e.g., a monolithic structure).

Upon rotation of the motor 66, the planet carrier 800 may rotate relative to the crankshaft anvil 814 a limited extent until the shoulders 808 contact the lugs 818. When the planet carrier 800 is free to rotate, the gear assembly 70 is effectively disabled. That is, the motor 66 just drives the rotation of the planet carrier 800, rather than the crankshaft anvil 814 (e.g., the crankshaft 178). The relative movement of the planet carrier 800 relative to the crankshaft anvil 814 introduces additional clearance in the drivetrain. In other words, the relative movement between the planet carrier 800 and the crankshaft anvil 814 contributes to the clearance region C (FIG. 12).

Although the disclosure has been described in detail with reference to certain preferred embodiments, variations and modifications exist within the scope and spirit of one or more independent aspects of the disclosure as described.

Various features of the disclosure are set forth in the following claims.

What is claimed is:

1. A power tool comprising:
a housing;
a motor supported within the housing, the motor including a motor shaft;
a selector movable between a first position and a second position;
an output;
a drivetrain coupling the motor shaft to the output;
an actuator; and
a controller configured to operate the motor to rotate the motor shaft in a first direction in response to a first actuation of the actuator, and to reverse the motor to rotate the motor shaft in a second direction opposite the first direction in response to a second actuation of the actuator following the first actuation,
wherein, when the selector is in the first position, the output is rotatable in a first output direction in response to rotation of the motor shaft in the first direction and in response to rotation of the motor shaft in the second direction, and
wherein, when the selector is in the second position, the output is rotatable in a second output direction opposite the first output direction in response to rotation of the motor shaft in the first direction and in response to rotation of the motor shaft in the second direction.

2. The power tool of claim 1, wherein the power tool includes a clearance region at least partially defined by tolerances in the drivetrain, wherein the motor shaft is rotatable relative to the output within the clearance region.

3. The power tool of claim 2, wherein, after reversing the motor, the controller accelerates the motor shaft in the second direction through the entire clearance region before torque is transmitted from the motor shaft to the output.

4. The power tool of claim 1, wherein the drivetrain includes a planetary transmission and a ratchet assembly.

5. The power tool of claim 1, wherein the controller is configured gradually reduce power supplied to the motor when the actuator is released.

6. The power tool of claim 5, wherein the controller is configured to reduce power supplied to the motor by 10% or less per millisecond when the actuator is released.

7. The power tool of claim 5, wherein the controller is configured to brake the motor to stop rotation of the motor shaft after gradually reducing power supplied to the motor.

8. A power tool comprising:
a housing;
a motor supported within the housing, the motor including a motor shaft;
an output;
a drivetrain coupling the motor shaft to the output such that rotation of the motor shaft rotates the output;
an actuator; and
a controller configured to
operate the motor to rotate the motor shaft in a first direction or a second direction opposite the first direction in response to actuation of the actuator,
gradually reduce power supplied to the motor by 10% or less per millisecond when the actuator is released, and
brake the motor to stop rotation of the motor shaft after gradually reducing the power supplied to the motor.

9. The power tool of claim 8, wherein the drivetrain includes a planetary transmission and a ratchet assembly.

10. The power tool of claim 8, wherein the controller is configured to reduce power supplied to the motor by 5% per millisecond when the actuator is released.

11. The power tool of claim 8, wherein the controller is configured to operate the motor to rotate the motor shaft in the first direction in response to receiving a signal from the actuator, and to reverse the motor to rotate the motor shaft in the second direction once a predetermined time period has elapsed after receiving the signal.

12. The power tool of claim 11, wherein the predetermined time period is between 10 milliseconds and 100 milliseconds.

13. The power tool of claim 11, wherein the power tool includes a clearance region at least partially defined by tolerances in the drivetrain, wherein the motor shaft is rotatable relative to the output within the clearance region.

14. The power tool of claim 13, wherein, after reversing the motor, the controller accelerates the motor shaft in the second direction through the entire clearance region before torque is transmitted from the motor shaft to the output.

15. The power tool of claim 8, wherein the controller is configured to operate the motor to rotate the motor shaft in the first direction in response to a first actuation of the actuator, and to reverse the motor to rotate the motor shaft in the second direction in response to a second actuation of the actuator following the first actuation.

16. The power tool of claim 8, wherein the controller is configured to reverse the direction of rotation of the motor shaft each time the actuator is actuated.

17. The power tool of claim 8, wherein the controller is configured to detect if the motor stalls during operation of the power tool, and wherein the controller is configured to reverse the motor in response to a detected stall.

18. A power tool comprising:
a housing;
a motor supported within the housing, the motor including a motor shaft;
an output rotatable in response to rotation of the motor shaft;
a drivetrain coupling the motor shaft to the output;
an actuator; and
a controller,
wherein the power tool includes a clearance region at least partially defined by tolerances in the drivetrain,
wherein the motor shaft is rotatable relative to the output within the clearance region,
wherein the drivetrain includes a ring gear that is rotatable relative to the housing.

19. The power tool of claim 18, wherein the drivetrain includes a collar coupled to the housing, wherein the collar receives the ring gear.

20. The power tool of claim 18, wherein the drivetrain includes a planet carrier, a crankshaft, and an anvil, wherein the planet carrier includes a recess for receiving the anvil, wherein the planet carrier is rotatable relative to the anvil, and wherein the anvil and the crankshaft are coupled together with a spline interface.
